(19) United States
(12) Patent Application Publication
(10) Pub. No.: US 2006/0270551 A1
(43) Pub. Date: Nov. 30, 2006

(54) Absorbent and method for separating acid gases from gas mixture

(76) Inventors: Jyung Ryong Jang, Yuseong-gu (KR); Hee Moon Eum, Yuseong-gu (KR); Dong Wha Kim, Yuseong-gu (KR); Jun Han Kim, Daedeok-gu (KR); Byoung Moo Min, Yuseong-gu (KR); Seung Chul Lee, Seoul (KR)

Correspondence Address: CANTOR COLBURN, LLP, 55 GRIFFIN ROAD SOUTH, BLOOMFIELD, CT, 06002, US

(21) Appl. No.: 11/285,963

(22) Filed: Nov. 23, 2005

(30) Foreign Application Priority Data
May 24, 2005 (KR) 10-2005-0043658

(51) Int. Cl. B01J 20/22

(52) U.S. Cl. 502/401

(57) ABSTRACT

Disclosed herein is an absorbent for separating acid gases, such as CO₂, H₂S and COS, from a gas mixture containing the acid gases wherein the absorbent comprises sodium glycinate. Further disclosed is a method for separating acid gases from a gas mixture using the absorbent.

### BACKGROUND OF THE INVENTION

1. Field of the Invention

The present invention relates to an absorbent and a method for separating acid gases from a gas mixture. More specifically, the present invention relates to an absorbent for separating acid gases, such as CO₂, H₂S and COS, from a gas mixture containing the acid gases wherein the absorbent comprises sodium glycinate, and a method for separating acid gases from a gas mixture using the absorbent.

2. Description of the Related Art

Recent industrial development has led to an increase in the concentration of carbon dioxide in the atmosphere. As a result, global warming has become a serious environmental problem. Thus, there is an urgent need to solve the problem. The use of fossil fuels, such as coal, oil and liquefied natural gas (LNG), in energy industries is principally responsible for the increase in the concentration of carbon dioxide in the atmosphere.

Extensive research is now being actively undertaken to develop techniques aimed at decreasing the concentration of carbon dioxide by separating and recovering carbon dioxide deriving from the use of fossil fuels. Separation techniques of carbon dioxide are largely classified into absorption, adsorption, membrane separation, and cryogenic distillation. Of these, the absorption technique is currently recognized to be most available for the separation of carbon dioxide from large-capacity generation sources of carbon dioxide. This is because the absorption technique is mainly employed in industrial plants, including oil refineries. That is, it is believed that the absorption technique can also be applied to large-scale plants, such as power plants.

Absorbents that can selectively absorb carbon dioxide are of large importance in the absorption technique. Monoethanolamine (hereinafter, abbreviated as ‘MEA’), which is a kind of alkanolamines, is the most widely used absorbent. Alkanolamines can be used to separate acid gases, such as SO₂, CO₂ and COS, from natural gases, synthetic gases and chemical reaction processing gases due to their superior absorption capability (high alkalinity). Despite this advantage, however, alkanolamines have the problem that a large quantity of energy is consumed to separate and regenerate carbon dioxide bonded to the absorbents. Specifically, since the superior absorption capability (high alkalinity) of alkanolamines lowers the difference in the unit absorption capacity of carbon dioxide according to the difference in temperature, a relatively large quantity of energy is required to regenerate the absorbed carbon dioxide. Carbon dioxide has been disposed in a small amount in conventional treatment processes of acid gases. Accordingly, economical inefficiency, such as considerable energy consumption, in the disposal of carbon dioxide has been recognized as a trivial issue. In connection with the reduction of the release of greenhouse gases, however, effective separation of carbon dioxide is becoming the most important factor.

Specific problems of conventional absorbents are as follows.

Firstly, since conventional absorbents, e.g., MEA, have a high alkalinity (3.3×10⁻¹⁰ at 25° C.), which is indicative of CO₂ absorption capability, much energy is consumed during regeneration after reaction with carbon dioxide. In addition, conventional absorbents cause severe corrosion of equipment.

Secondly, most conventional absorbents produce a strong ammonia smell, particularly when aqueous solutions are heated to remove carbon dioxide contained therein.

Thirdly, conventional absorbents leave by-products, such as a cyclic carbamate and a urea (a product by condensation of two amine molecules and one carbon dioxide molecule), when an aqueous solution containing carbon dioxide is heated to remove the carbon dioxide. These by products rapidly deteriorate the absorbents, making it difficult to repeatedly use the absorbents for a long period of time.

### SUMMARY OF THE INVENTION

Therefore, the present invention has been made in view of the above problems, and it is one object of the present invention to provide an absorbent for separating acid gases from a gas mixture wherein the absorbent has excellent regenerability, has an absorption capacity sufficient to separate a large amount of carbon dioxide, is less corrosive, and is economically advantageous, as compared to conventional absorbents.

It is another object of the present invention to provide a method for separating acid gases from a gas mixture using the absorbent.

In accordance with one aspect of the present invention for achieving the above objects, there is provided an absorbent for separating acid gases from a gas mixture wherein the absorbent comprises sodium glycinate. The absorbent may be composed of an aqueous solution containing 10˜60% by weight of sodium glycinate.

In accordance with another aspect of the present invention, there is provided a method for separating acid gases from a gas mixture, comprising the step of contacting an absorbent with a gas mixture to allow the absorbent to absorb acid gases contained in the gas mixture wherein the absorbent comprises sodium glycinate.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram of an apparatus for measuring the equilibrium absorption capacity of carbon dioxide using a wetted wall surface; and

FIG. 2 is a schematic view of an experimental apparatus for measuring the equilibrium absorption capacity of carbon dioxide of an absorbent at atmospheric pressure.

### DESCRIPTION OF THE PREFERRED EMBODIMENTS

Since sodium glycinate, which is a kind of sodium amino acids, has a large difference in unit absorption capacity according to the difference of temperature when compared to conventional absorbents, it has superior regenerability and a large absorption capacity sufficient to separate a relatively large amount of carbon dioxide. In addition, sodium glycinate can be produced on an industrial scale at low costs and is less corrosive due to its low alkalinity.

The fact that sodium glycinate has superior thermal and chemical resistance is clearly proven by the mechanism that sodium glycinate and conventional absorbents absorb and separate carbon dioxide. As depicted in Reaction Scheme 1, when monoethanolamine (MEA) as a conventional absorbent absorbs carbon dioxide to form a carbonate, which is in equilibrium with a carbamic acid having an amide bond. Then, when the carbamic acid is heated to separate carbon dioxide, the intramolecular hydroxyl group attacks the carbonyl group to form a stable cyclic carbamate. Since the cyclic carbamate cannot absorb carbon dioxide any longer, MEA must be continuously supplied. This increases the content of the carbarnate and thus the carbon dioxide absorption capability of MEA is progressively reduced. To solve this problem, the MEA must be hydrolyzed by the addition of Sodium hydroxide to regenerate the carbamate into MEA.

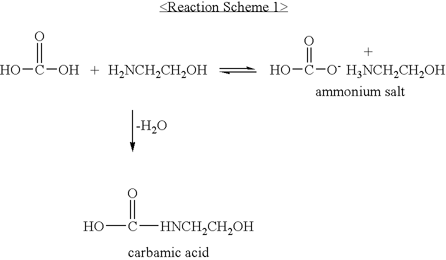

On the other hand, sodium glycinate is not readily cyclized due to the presence of a slightly hydrophilic carboxyl group instead of hydroxyl group, as depicted in Reaction Scheme 2. Although sodium glycinate is cyclized to form an acid anhydride, the acid anhydride is easily hydrolyzed by contact with water, thus preventing the formation of a cyclic carbarnate. Accordingly, sodium glycinate is highly efficient for the absorption and regeneration of carbon dioxide.

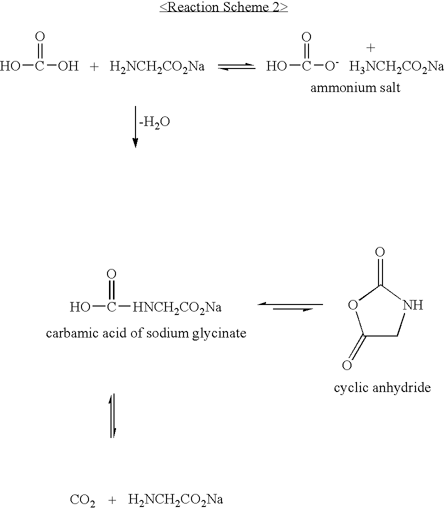

The absorbent of the present invention can be composed of an aqueous sodium glycinate solution, preferably an aqueous solution containing 10˜60% by weight of sodium glycinate. Taking the solubility of sodium glycinate in water into consideration, the concentration of sodium glycinate in the aqueous solution may be appropriately controlled within this range, depending on the change in CO₂ concentration.

The method for separating acid gases from a gas mixture according to the present invention comprises the step of contacting the absorbent with a gas mixture to allow the absorbent to absorb acid gases contained in the gas mixture.

When the gas mixture containing acid gases, such as CO₂, H₂S and COS, comes into contact with the absorbent in the form of an aqueous sodium glycinate solution, the acid gases contained in the gas mixture are absorbed in the absorbent and then removed.

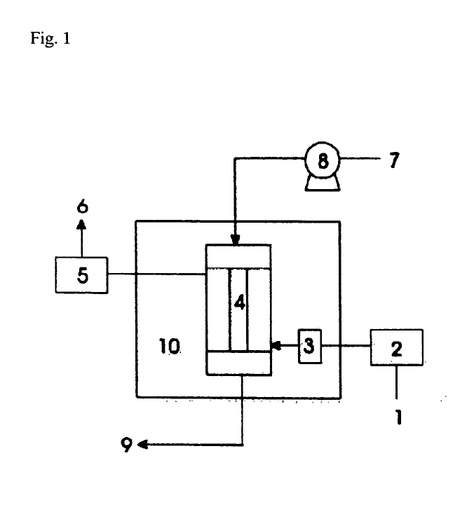

FIG. 1 is a schematic diagram of an apparatus for measuring the equilibrium absorption capacity of carbon dioxide using a wetted wall. Referring to FIG. 1, acid gases, including CO₂, H₂S and COS, discharged from equipments, e.g., refineries and thermoelectric power plants, are introduced into a gas storage tank 3 at a constant flow rate per unit time through a gas pressure controller 2 via a gas inlet 1. After the gas mixture is saturated with water vapor in the gas storage tank 3, it is introduced into a wet-type tubular absorption reactor 4 installed in an air thermostat 10. On the other hand, an absorbent in the form of an aqueous solution is pressurized by the action of a pump 8 through an absorbent inlet 7 and is fed into the wet-type tubular absorption reactor 4. The gas mixture saturated with water vapor is mixed with the absorbent by vapor-liquid contact to collect the acid gases, such as carbon dioxide, in the mixed solution. Subsequently, the mixed solution is recovered through an absorbent outlet 9, and purified discharge gases free of the acid gases, such as carbon dioxide, are discharged to a gas outlet 6 via a gas flow rate recorder 5.

The present invention will now be described in more detail with reference to the following experimental examples. However, these examples are given for the purpose of illustration and are not to be construed as limiting the scope of the invention.

### EXPERIMENTAL EXAMPLE 1

Comparison of Alkalinity

Alkalinity is a measure of the capacity of an aqueous system to neutralize an acid, unlike alkaline or alkali. Substances causing the alkalinity include hydroxide (OH⁻), bicarbonate (HCO₃⁻), carbonate (CO₃²⁻), and the like. The alkalinity was measured in accordance with the procedure of KS M ISO9963-1.

The alkalinity values of monoethanolamine (MEA) and sodium glycinate (SG) are shown in Table 1 below. It is obvious from the data shown in Table 1, changes in alkalinity according to the changes in temperature is negligible. As the concentration of the absorbents increases, the alkalinity of monoethanolamine is higher than that of sodium glycinate. Accordingly, in the case where the absorbents are used at the same concentration, sodium glycinate has a lower akalinity than monoethanolamine, leading to a reduction in corrosion.

TABLE 1
Alkalinity of monoethanolamine (MEA) and sodium glycinate
(SG) according to changes in temperature

| Test | | | | | | |
|---|---|---|---|---|---|---|
| | Temp. | Concentration of absorbent (aqueous solution) | | | | |
| Absorbent | (° C.) | 10 wt % | 20 wt % | 30 wt % | 40 wt % | 50 wt % |
| MEA | 20 | 7.290 | 14.123 | 20.487 | 28.426 | 36.002 |
| | 40 | 7.251 | 14.373 | 20.802 | 28.811 | 36.112 |
| | 60 | 7.288 | 14.575 | 21.064 | 29.116 | 36.405 |
| SG | 20 | 4.278 | 8.938 | 13.145 | 17.946 | 22.392 |
| | 40 | 3.984 | 8.411 | 13.277 | 18.128 | 22.299 |
| | 60 | 4.106 | 8.655 | 13.233 | 18.006 | 22.314 |

### EXAMPLE 2

Comparison of CO₂ Unit Absorption Capacity of Absorbents Accoring to Difference in Temperature

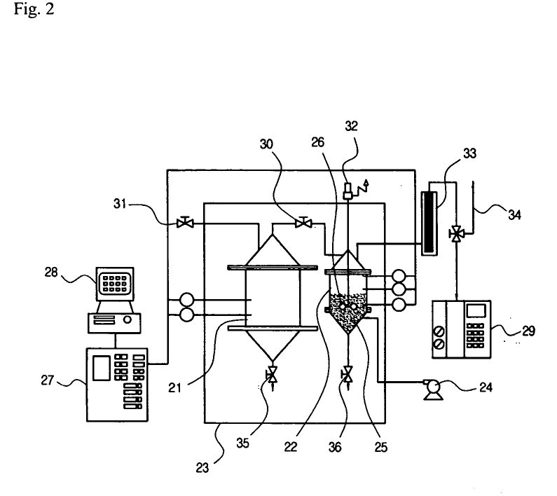

FIG. 2 is a schematic view of an experimental apparatus for measuring the equilibrium absorption capacity of carbon dioxide of an absorbent at atmospheric pressure. The experimental apparatus comprises a storage tank 21 for feeding an exact amount of carbon dioxide at a constant temperature and a reactor 22 for reacting the carbon dioxide with the absorbant at a constant temperature. The apparatus was installed in a forced convection oven (OF-22, JEIO TECH.) to maintain the temperature at a constant level. A pump 24 (Lab alliance) was operated in such a manner that the absorbent was fed in an exact amount. Four baffles 26 were installed within the reactor 22 so that the absorbent and carbon dioxide were uniformly mixed to rapidly perform the reaction between the absorbent 25 and carbon dioxide. Thermometers (T) were arranged in both vapor and liquid zones within the reactor 22, and a pressure gauge P was arranged in the vapor zone only. The pressure gauge P and the thermometers T were connected to a hybrid recorder 27 (DR-230, Yokogawa), which transmits the measured values to a computer 28 to store in a data file. Before experiment, a predetermined amount of carbon dioxide gas was filled into the carbon dioxide storage tank 21 and the reactor 22 was maintained at a nitrogen atmosphere free of carbon dioxide gas. Then, the content of carbon dioxide gas in the reactor 22 was analyzed by a gas chromatography (GC) 29. Nitrogen gas was sufficiently purged into the reactor 22 until no carbon dioxide gas was detected. Thereafter, 100 g of the absorbent was fed into the reactor 22 by the action of a pump 24. After the temperature of the oven 23 was adjusted to an experimental temperature, an equilibrium pressure was measured at the initial temperature for the experiment. This equilibrium pressure was a base pressure of the nitrogen gas and the absorbent. Immediately after the temperature reached the experimental temperature, a valve 30 of the carbon dioxide storage tank 21 opened to transfer the carbon dioxide gas to the reactor 22. Thereafter, when the equilibrium pressure and the temperature of the carbon dioxide reactor 22 were maintained at constant values, it was determined that the reaction was completed. Changes in the pressure of the carbon dioxide reactor 22 and the carbon dioxide storage tank 21 were measured, and the equilibrium load of the carbon dioxide and the amount of the carbon dioxide supplied were calculated from the measured values. The partial pressure was calculated to determine the solubility. The experiments on an aqueous solution of 20 wt % of monoethanolamine (MEA) and an aqueous solution of 20 wt % of sodium glycinate (SG) were performed at 50° C. and 75° C.

Although not explained herein, numeral 31 designates a gas inlet valve, numeral 32 designates a motor for rotating the baffles, numeral 33 designates a condenser, numeral 34 designates a discharge port, and numerals 35 and 36 designate discharge valves.

The unit absorption capacity of carbon dioxide of the monoethanolamine (MEA) was compared with that of the sodium glycinate (SG) according to the changes in temperature, and the results are shown in Table 2 below. As can be seen from the data shown in Table 2, sodium glycinate has a large difference in unit absorption capacity according to the difference of temperature when compared to monoethanolamine (MEA). That is, sodium glycinate has a larger unit absorption capacity at low temperatures than monoethanolamine, but monoethanolamine has a larger unit absorption capacity at high temperatures than sodium glycinate. These results indicate that sodium glycinate has superior regenerability to monoethanolamine after absorption and separation of carbon dioxide.

TABLE 2
Unit absorption capacity of carbon dioxide of monoethanolamine (MEA)
and sodium glycinate (SG) according to changes in temperature

| MEA (50° C.) | | MEA (75° C.) | | Sodium glycinate (50° C.) | | Sodium glycinate (75° C.) | |
|---|---|---|---|---|---|---|---|
| Absorption | Partial | Absorption | Partial | Absorption | Partial | Absorption | Partial |
| capacity¹ | pressure² | capacity¹ | pressure² | capacity¹ | pressure² | capacity¹ | pressure² |
| 0.2473 | 5.9953 | 0.2518 | 4.2036 | 0.2305 | 4.2725 | 0.2196 | 2.1363 |
| 0.4537 | 13.1621 | 0.4533 | 28.5294 | 0.4731 | 115082 | 0.4383 | 9.2341 |
| 0.5328 | 47.5490 | 0.5181 | 85.0369 | 0.6463 | 72.4261 | 0.5424 | 58.6437 |
| 0.5720 | 89.8607 | 0.5443 | 152.5013 | 0.7311 | 174.8286 | 0.6242 | 170.6250 |
| 0.6036 | 142.9226 | 0.5579 | 201.9109 | 0.7551 | 200.7394 | 0.6471 | 223.6869 |

Note.
¹mole-CO2/mole-MEA
²P_{co2}, kPa

As apparent from the above description, since the absorbent for separating acid gases from a gas mixture according to the present invention uses sodium glycinate, it has a large difference in unit absorption capacity according to the difference of temperature when compared to conventional absorbents and therefore shows superior regenerability. In addition, the absorbent of the present invention has a large absorption capacity sufficient to separate a relatively large amount of carbon dioxide.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An absorbent for separating acid gases from a gas mixture wherein the absorbent comprises sodium glycinate.

2. The absorbent according to claim 1, wherein the absorbent is composed of an aqueous solution containing 10˜60% by weight of sodium glycinate.

3. A method for separating acid gases from a gas mixture, comprising the step of contacting an absorbent with a gas mixture to allow the absorbent to absorb acid gases contained in the gas mixture wherein the absorbent comprises sodium glycinate.

4. The method according to claim 3, wherein the absorbent is composed of an aqueous solution containing 10˜60% by weight of sodium glycinate.
